(19) United States
(12) Patent Application Publication
(10) Pub. No.: US 2021/0007262 A1
(43) Pub. Date: Jan. 14, 2021

(54) Device for Collecting, Depositing, and Compacting Soil into a Container or Hole

(71) Applicant: Mark Dodd, Allen, TX (US)

(72) Inventor: Mark Dodd, Allen, TX (US)

(21) Appl. No.: 16/918,412

(22) Filed: Jul. 1, 2020

Related U.S. Application Data
(60) Provisional application No. 62/921,813, filed on Jul. 10, 2019.

(51) Int. Cl. A01B 1/00

(52) U.S. Cl. CPC A01B 1/00; A01G 9/02

(57) ABSTRACT

A device for collecting and distributing material into a receptacle having a receptacle curvature includes: a tapered wall; and a tamping flange adjoining the tapered wall. The tapered wall has a tapered wall curvature that approximates the receptacle curvature. The tamping flange is configured to compact the material into the receptacle.

### CROSS-REFERENCE TO PRIOR APPLICATION

This patent application claims the benefit of U.S. Provisional Patent Application No. 62/921,813, filed on Jul. 10, 2019, the entire disclosure of which is hereby incorporated by reference herein.

### FIELD

The present invention is directed to a device for collecting, transferring, depositing, and compacting soil, fertilizer, or other materials into a container, such as a pot, or a hole.

### BACKGROUND

People often plant flowers and plants into pots, containers, or holes, which necessitates the collection and addition of soil and other materials for such plantings. Often times such soil comes in pre-packaged in plastic bags. Furthermore, after a plant and its root ball are placed into a pot or hole, it usually leaves only a narrow space in which soil must deposited. Also, after the soil is distributed into pots or other receptacles, it then needs to be compacted.

Currently, one method for transferring soil and various other materials into pots and containers when planting is the use of the hands. This method is slow, messy, and frequently results in spilled soil that requires clean up and also creates wasted material. Additionally, using the hands to compact soil into a narrow area between the wall of the pot and the plant can damage delicate stems and flowers.

Alternatively, another current method for transferring soil when planting is the use of a trowel, which is essentially a small, narrow, pointed shovel with a handle. Because of the narrow, pointed nature of trowels, only smaller amounts of soil can be collected and transferred at one time. Their shape also makes them prone to spilling when moving the trowel. Additionally, the presence of a traditional handle makes collecting packaged soil from a bag difficult as the handle can catch against the bag. Furthermore, a handle limits the angle at which the trowel can be tilted to distribute soil neatly into a pot or container. Also, a trowel does not offer an effective way to compact soil around potted plants.

Therefore, a need arises for a device that can neatly and efficiently collect and transfer larger amounts of soil and then deposit such soil into narrow, circular, or angled spaces of pots without damaging the plant, and such a device that can also be used to compact deposited soil without contacting the plant.

### SUMMARY

In an embodiment, the present invention provides a device for collecting and distributing material into a receptacle having a receptacle curvature, the device comprising: a tapered wall; and a tamping flange adjoining the tapered wall, wherein the tapered wall has a tapered wall curvature that approximates the receptacle curvature, and wherein the tamping flange is configured to compact the material into the receptacle.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a top, front, left side perspective view of an embodiment of the device of the present invention with a wide curved face.

FIG. 2 shows a top plan view of the device of FIG. 1.

FIG. 3 shows a bottom plan view of the device of FIG. 1.

FIG. 4 shows a left side elevational view of the device of FIG. 1 incorporating a tamping flange at the top of the device.

FIG. 5 shows a right side elevational view of the device of FIG. 1 incorporating a tamping flange at the top of the device.

FIG. 6 shows the device of FIG. 1 depositing soil into a circular container as the device aligns with the perimeter or curvature of the container.

### DETAILED DESCRIPTION

People often purchase plants and flowers with the intention of planting them in pots and containers. These plants are typically sold in a temporary container. Once removed from the temporary container, the plant typically has a cylindrical mass of compacted dirt and roots known as a root ball. The plant and attached root ball is then placed into a hole, flowerpot, or container. This receiving receptacle is typically larger than the root ball. Once the plant and attached root ball are placed in the receiving container it leaves a curved, narrow void between the plant's root ball and the circumference of the container's perimeter wall. This area then needs to be filled with additional potting soil, typically purchased in a prepackaged bag. The additional soil is then tamped down and compacted into the above empty spaces.

Consumers and gardeners currently are limited in effective methods to quickly and neatly fill such narrow, curved perimeter void areas after the plant has been placed in the container. Therefore, a need arises for a method of neatly and efficiently transferring soil and distributing it into narrow, curved spaces of containers, then compacting that soil, while minimizing contact with delicate plants.

The current invention solves these problems by utilizing a wide contoured face that is curved or angled as to mirror or approximate the arc of pots and containers. Such a shape allows for larger collection of soil and allows for such soil to be deposited precisely into the narrow, curved areas between the plant and the receptacles' perimeter without contacting or damaging the plant. Unlike a trowel, the current invention does not utilize a traditional handle that could catch on bags when extracting soil or could cause uneven soil distribution into containers. Furthermore, the present invention utilizes a tamping flange along the top of the device which, when the device is turned upside down, can be used to compact soil within such narrow and curved spaces between the plant and the receptacles' perimeter. Such tamping flange is also curved or angled as to mirror or approximate the arc or angle of the receptacle.

Also in accordance with the principles of the invention, the device may incorporate serrated areas at its base. The serrated areas can help the device penetrate into soil.

Also in accordance with the principles of the invention, the device may utilize finger or thumb depressions or textured areas on the front or back of the device to increase the user's ability to grip the device.

In an embodiment, the present invention provides a device for collecting and distributing soil, fertilizer, or other materials into a pot, container, hole, or other receptacle.

In an embodiment, the present invention provides a device with a curved wall and protruding flange, for collecting and distributing soil or other matter into narrow areas within a circular container then compacting such deposited soil.

In an embodiment, the present invention provides a scoop, which is curved in such a way as to mirror or approximate the curvature of a pot or container. In an embodiment, the scoop incorporates a flange or lip across the top of the device.

In an embodiment, the present invention provides a device used to place matter into narrow spaces.

In an embodiment, the present invention provides a curved device incorporating one or more recessed areas which accommodate fingers or thumbs of the user gripping the device.

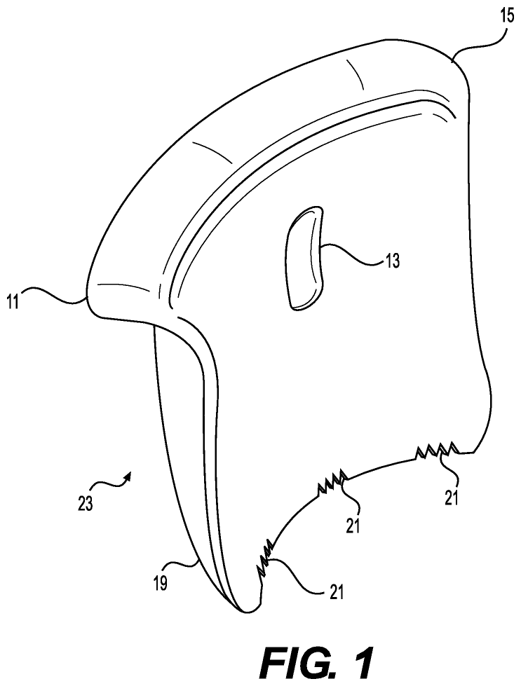

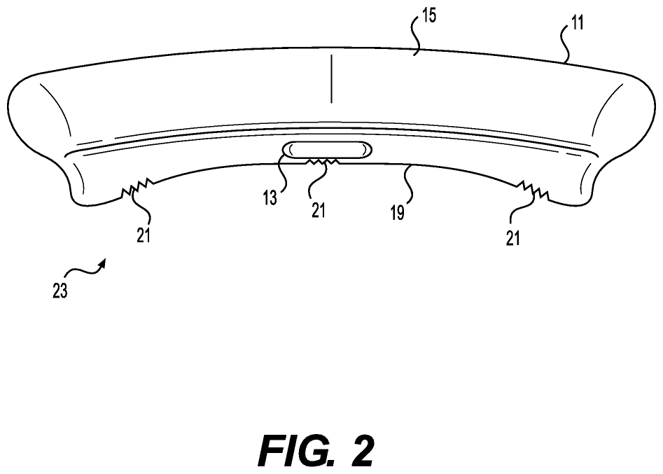

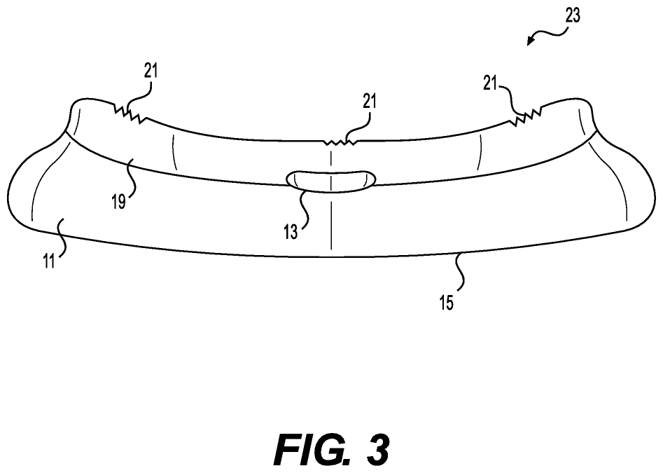

Referring to FIGS. 1-6, the device 23 according to the principles of the invention includes a tapered wall 19 that tapers from the top of the tapered wall 19 toward the bottom of the tapered wall 19. The device 23 includes a serrated edge 21 at a bottom of the tapered wall 19 and a curved tamping flange 15 at the top of the tapered wall 19. The tamping flange 15 has a beveled edge 11. The device 23 includes an embossed or recessed finger pad 13 for enhanced grip by the user of the device. The tapered wall 19 has a wide contoured face that is curved or angled as to mirror or approximate the arc of pots and containers. The tamping flange 15 is also curved or angled as to mirror or approximate the arc of pots and containers.

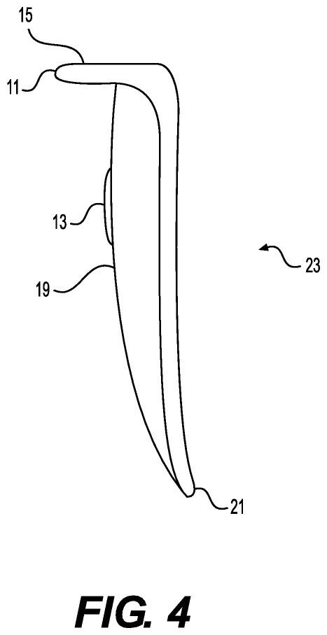

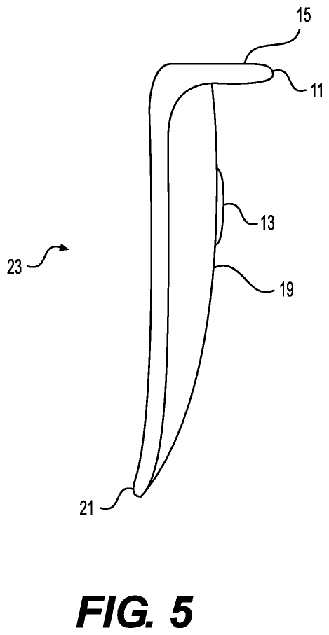

FIGS. 4-5 show the device 23 with the curved tamping flange 15 and the tapered wall 19.

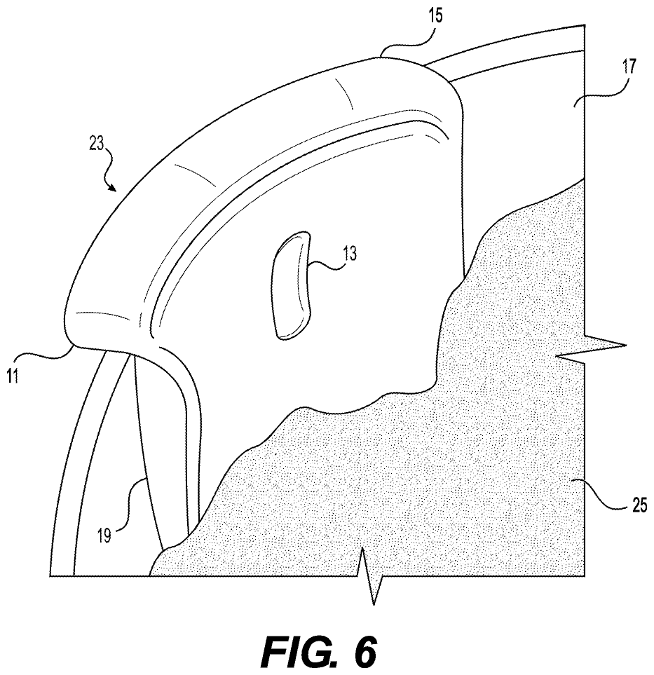

Referring to FIG. 6, the device 23 according to the principles of the invention is shown to have a curvature that is similar to the curved perimeter of a pot 17. The tamping flange 15 includes beveled edge 11. As shown in FIG. 6, the device 23 is disposed between the wall of pot 17 and soil/fertilizer/planting material 25.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

11 beveled edge
13 embossed or recessed finger pad
15 curved tamping flange
17 pot
19 tapered wall
21 serrated edge
23 device
25 soil/fertilizer/planting material

We claim:

1. A device for collecting and distributing material into a receptacle having a receptacle curvature, the device comprising:
a tapered wall; and
a tamping flange adjoining the tapered wall,
wherein the tapered wall has a tapered wall curvature that approximates the receptacle curvature, and
wherein the tamping flange is configured to compact the material into the receptacle.

2. The device of claim 1, wherein the tamping flange comprises a continuous surface that extends from a first edge of the tapered wall to a second, opposite edge of the tapered wall.

3. The device of claim 1, wherein the tapered wall comprises an embossed or recessed finger pad.

4. The device of claim 3, wherein the embossed or recessed finger pad is disposed equidistantly between a first edge of the tapered wall and a second, opposite edge of the tapered wall.

5. The device of claim 1, wherein the tapered wall comprises at least one serrated area at a side of the tapered wall opposite from where the tamping flange adjoins the tapered wall.

6. The device of claim 1, wherein the tamping flange comprises a beveled edge.

7. The device of claim 1, wherein the tamping flange has a tamping flange curvature that approximates the receptacle curvature.

8. The device of claim 1, wherein the receptacle comprises a pot.

9. A scoop for depositing material into a container, the scoop comprising:
a tapered wall, the tapered wall tapering from a top of the tapered wall to a bottom of the tapered wall; and
a tamping flange disposed on the top of the tapered wall, the tamping flange being arranged orthogonally with respect to the tapered wall when the scoop is viewed from a side of the scoop,
wherein the tamping flange comprises a continuous surface that extends from a first edge of the tapered wall to a second, opposite edge of the tapered wall.

10. The scoop of claim 9, wherein the tapered wall has a curvature that approximates a curvature of the container.

11. The scoop of claim 9, wherein the tamping flange has a curvature that approximates a curvature of the container.

12. The scoop of claim 9, wherein the tapered wall comprises an embossed or recessed finger pad.

13. The scoop of claim 9, wherein the tapered wall comprises at least one serrated are at a side of the tapered wall opposite from where the tamping flange adjoins the tapered wall.

14. The scoop of claim 9, wherein the tamping flange comprises a beveled edge.

15. The scoop of claim 9, wherein the tamping flange is configured to compact the material into the container.

16. The scoop of claim 9, wherein the container comprises a pot.

17. A device of collecting and depositing material into a container, the container having a container curvature, the device comprising:
a wall having a top and a bottom; and
a tamping flange disposed on the wall at the top thereof, the tamping flange being positioned orthogonally with respect to the wall when the device is viewed from a side thereof,
wherein the wall and the tamping flange each have a curvature that mirrors the container curvature.

18. The device of claim 17, wherein the tamping flange is configured to compact the material into the container.

19. The device of claim 17, wherein the tamping flange comprises a continuous surface that extends from a first edge of the wall to a second, opposite edge of the wall.

20. The device of claim 17, wherein the tamping flange comprises a surface configured to allow a user of the device to grasp the device.
